(19) United States
(12) Patent Application Publication
(10) Pub. No.: US 2008/0255818 A1
(43) Pub. Date: Oct. 16, 2008

(54) Test System Design Tool With Model-Based Tool Support

(76) Inventors: Stanley T. Jefferson, Palo Alto, CA (US); Douglas M. Baney, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/733,909

(22) Filed: Apr. 11, 2007

(51) Int. Cl. G06F 17/50

(52) U.S. Cl. 703/13

(57) ABSTRACT

A computer aided design apparatus performs context-sensitive modeling of a test and measurement system that includes a plurality of actual system components including instruments and interconnections therebetween. The apparatus comprises a graphical user interface; a library of models of system components, each model including a graphical representation of the system component and a definition of properties of the system component; and a system model generator for selecting and interconnecting the system components to produce a model of the system, for displaying the model on the graphical user interface as a combination of the graphical representations of the components, and for simulating operation and testing of the system. The system model generator operates in (i) a design mode, for constructing and displaying the model of the system from the models of system components as a graphical representation thereof; (ii) a simulation/analysis mode, for predicting performance characteristics of the system; and (iii) a runtime mode for linking to actual system components and operating the actual system components by manipulating the model through the graphical user interface.

### BACKGROUND OF THE INVENTION

The invention relates to test and measurement systems.

Conventionally, test systems and control systems have been specified using different modeling tools or methods for different aspects of the system. Attempts to integrate different modeling tools, visualization, simulation, and documentation have employed techniques generally encompassed by titles in the form “Computer Aided X” or CAx, where the “X” stands for a process or technique employing computer or software technology. CAx is a broad term describing the use of computer technology to aid in the design, analysis and manufacture of products. In one familiar example, the “X” stands for “design”, i.e., Computer Aided Design” or “CAD.”

An example of such a CAx product is CATIA V5, a suite of tools developed by Dassault Systemes, which allows simultaneous design and integration of electrical, fluid and mechanical systems within a 3D digital mock-up, while optimizing space allocation. CAx, and particularly CAD, has been employed in fields such as automotive and aerospace. However, the domain of test systems heretofore has not been well addressed.

### SUMMARY OF THE INVENTION

A computer aided design apparatus performs context-sensitive modeling of a test and measurement system that includes a plurality of actual system components including instruments and interconnections therebetween. The apparatus comprises a graphical user interface; a library of models of system components, each model including a graphical representation of the system component and a definition of properties of the system component; and a system model generator for selecting and interconnecting the system components to produce a model of the system, for displaying the model on the graphical user interface as a combination of the graphical representations of the components, and for simulating operation and testing of the system. The system model generator operates in (i) a design mode, for constructing and displaying the model of the system from the models of system components as a graphical representation thereof; (ii) a simulation/analysis mode, for predicting performance characteristics of the system; and (iii) a runtime mode for linking to actual system components and operating the actual system components by manipulating the model through the graphical user interface.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram of a component model database.

FIG. 2 is a block diagram of a system embodying the invention.

FIGS. 3 and 4 are illustrations of visualizable models of components, for display on a graphical user interface, as per an embodiment of the invention.

FIG. 5 is a diagram of a test system, as modeled and displayed by an embodiment of the invention using the component models of FIG. 4.

FIG. 6 is a flowchart showing operation of an embodiment of the invention.

### DETAILED DESCRIPTION

Consider a test system consisting of a rack of instruments and other devices cabled together. The mechanical aspects may be modeled in software, using a CAD tool or drawing. The cable connections may be listed in a database or document. The software model is written with assumptions that the cables and instruments are configured in a certain way. System simulations may be written (e.g. in a language such as the Simulink platform, provided by The MathWorks, Inc.) using assumptions about the configuration of cables, instruments and software.

The mechanical specification, cabling specification, software specification, and simulation specification are independent specifications that typically don't interoperate. The consistency of these specifications is likely only verified occasionally and manually by a human. When changes to the configuration of the system are made, other specifications have to also be changed. This process could be a source of errors or inconsistency. Errors could be very costly in terms of system damage or time spent troubleshooting. Also, managing, maintaining, and integrating separate views of a system is costly in terms of time and tools.

An embodiment of the invention provides modeling and system design capability, in which the electrical, optical, and mechanical design of a system, for instance a test system, is specified using an integrated method and tool. Errors from mismatched or outdated specifications are eliminated. Because there is a single design tool and single model representation, design management and maintenance costs are effectively kept under control. The ability to mix simulated hardware, actual hardware, and software allows system testing and software development to proceed without having all of the actual hardware, or a completely realized system.

An embodiment of the invention facilitates aspects such as user visualization of test system connections, simulation of system behavior, operation of actual hardware comprising the system, extending system behavior with software or firmware specifications, and documentation of system assembly. The GUI in an embodiment of the invention is context-sensitive, and provides a versatile model of the modeled system.

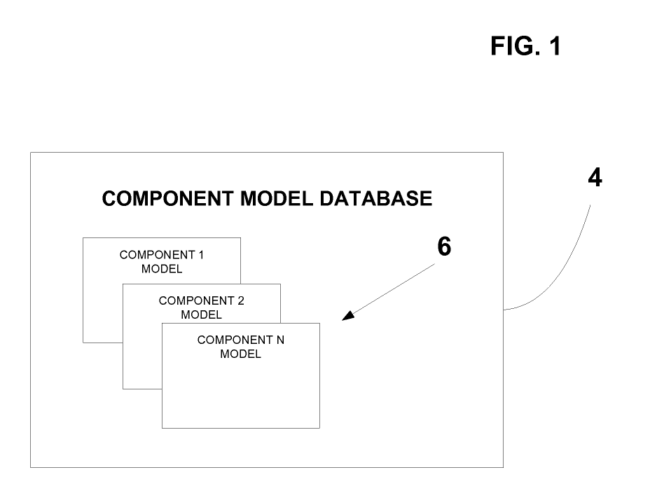

FIG. 1 is a block diagram of a database 4 containing models 6 of components and measurement instruments that make up a system to be designed (i.e., modeled) by a CAD system. The models 6 are shown individually as component models 1 through N.

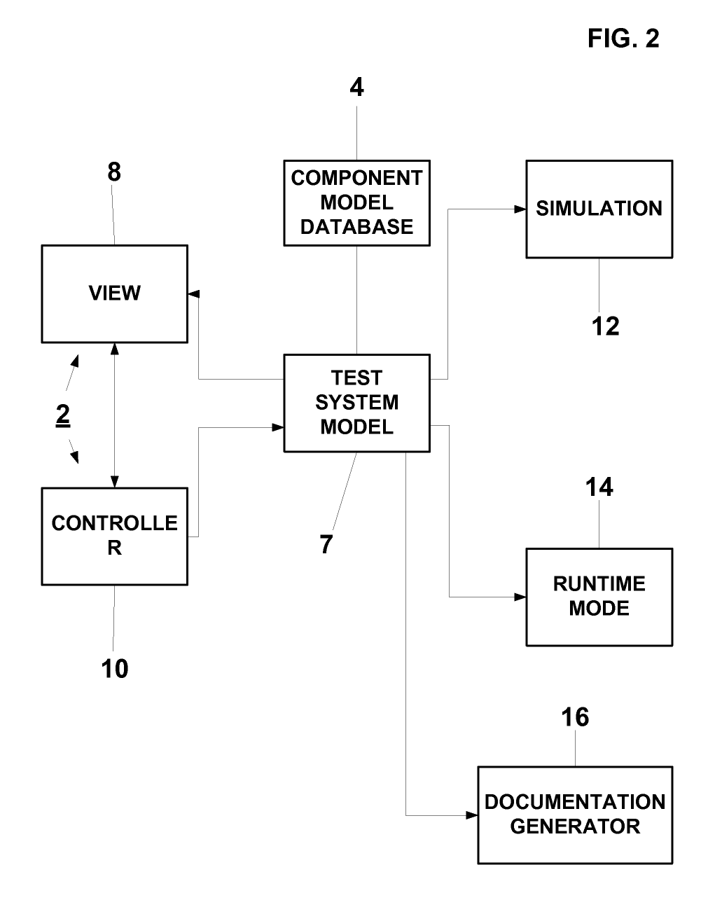

FIG. 2 is a block diagram of a system embodying the invention. The embodiment may, for instance, utilize a Model/View/Controller (MVC) software pattern. A component model database 4, such as that of FIG. 1, is provided. A test system model 7 encompasses all of the design information, including physical, mechanical, electrical, connections, 3D placement of components, and viewing position. The test system model 7 is made of a combination of models of various individual components taken from the component model database 4.

A graphical user interface (GUI), generally shown as 2, is provided. A view 8 is the graphical 3D representation of the model 7 presented to the user, and could include other information and annotations. A controller 10 of the graphical user interface 2 handles user input and modifications to the model. The MVC core is extended with a simulation and analysis module 12 that works directly from the model 7. The MVC core is also extended with a runtime mode module 14. Other modules are for generating documentation, assembly instructions, etc., generally shown as a documentation generator 16.

Much of the discussion herein addresses, by way of example, modeling a test system that includes a device under test (hereinafter “DUT”) and test equipment for performing tests on such a DUT. It will be understood, however, that many other types of systems may also be modeled, substantially as described herein, employing additional embodiments of the present invention.

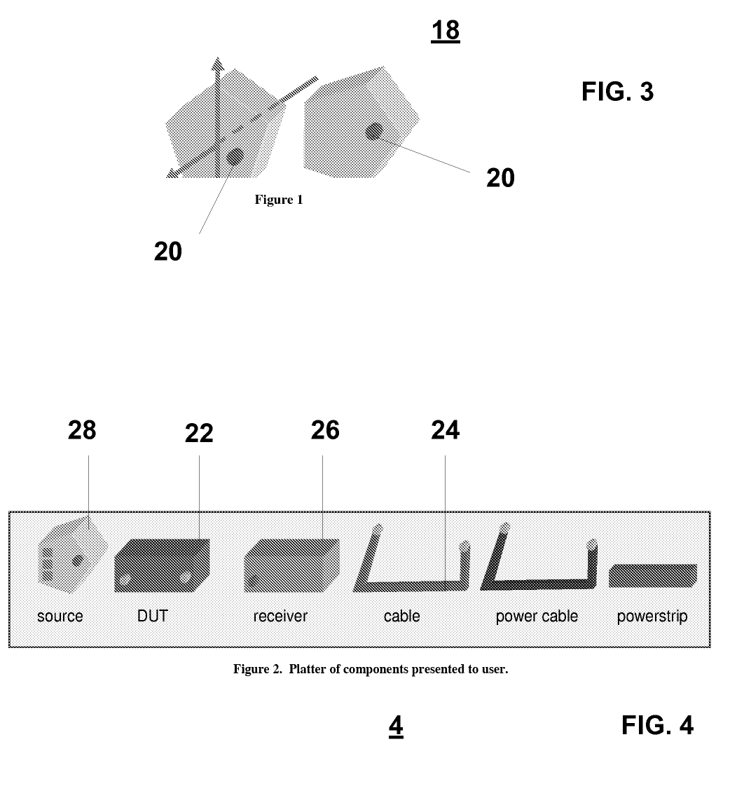

FIG. 3 shows an example of a visualizable and displayable image of one of the component models 6 within the component model database 4 of an embodiment of the invention. The illustrated component model 18 is shown in two views specifically in two different rotational orientations. Each view is shown in an abstract fashion as a geometric figure (in this instance, a pentagonal prism).

Each view of the component model 18 shows a connector 20, for coupling to a cable, which would be a separate one of the component models 6 in the component model database 4. For instance, the component model 18 might be a model of a spectrum analyzer, which is to be employed in a test and measurement system. In the system to be modeled, the spectrum analyzer might be coupled through a cable to another piece or equipment. In the system model, the component model 18 of the spectrum analyzer would be coupled, through a model of a cable (not shown), to a model of another piece of equipment (also not shown).

As the component model 18 is rotated or displaced in any plane, the function of the component model 18 is maintained. Moreover, the electrical and mechanical properties (8, 10, 12, 14, and 16) of the component model 18 shown in FIG. 2 are associated with the component model 18 for design rule validation and system simulation. A user employs GUI input devices such as a standard computer mouse to point and track the screen position of the component model 18, and to activate an operation upon placement of the graphical interface pointer on the component model 18.

The user may employ the GUI 2 to pull up and assemble a system model out of multiple component models, all component models having representations that are available from a library. FIG. 4 displays, for example, a small library of component models that are available from the database 4 for user selection through the graphical user interface 2, or for selection as part of a system design specification that is input to the CAD apparatus. The images in FIG. 4 are stylized, or schematic, in appearance, but other embodiments of the invention may use realistic, photographic quality 3D models, etc.

From a library such as that of FIG. 4, the user selects components, builds the system model, brings electrical power to the instruments and the device under test (DUT), provides connections between the instruments and DUT, provides communication connections such as LAN and trigger, etc. Such model building can include physical placement and mechanical connection of the components, as well as their electrical power and signal interconnections. An embodiment also provides the user with the capability of employing user-defined components and elements, and adding the user-defined components and elements to the library for future use.

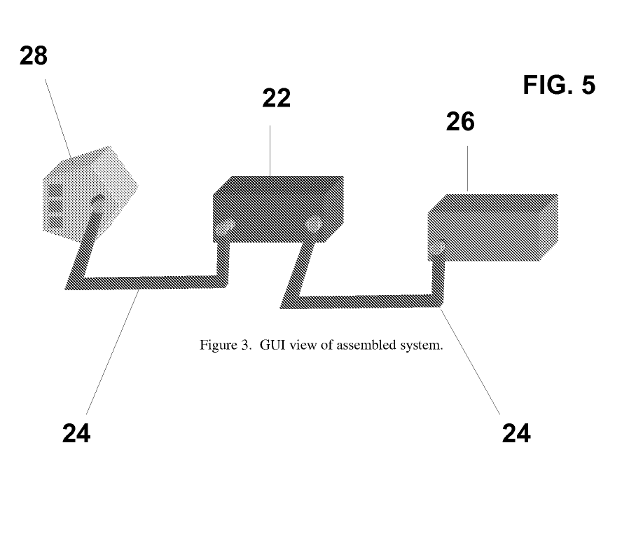

FIG. 5 portrays an example of a system model assembled from some of the component models in the library of FIG. 4. The system model includes a device under test (DUT) 22, coupled with cables 24 to a receiver 26 and to a source 28. The assembled system model has a logical mapping of graphical connections and instrument states to an analysis engine that simulates the system performance based on the models of the system connections and states.

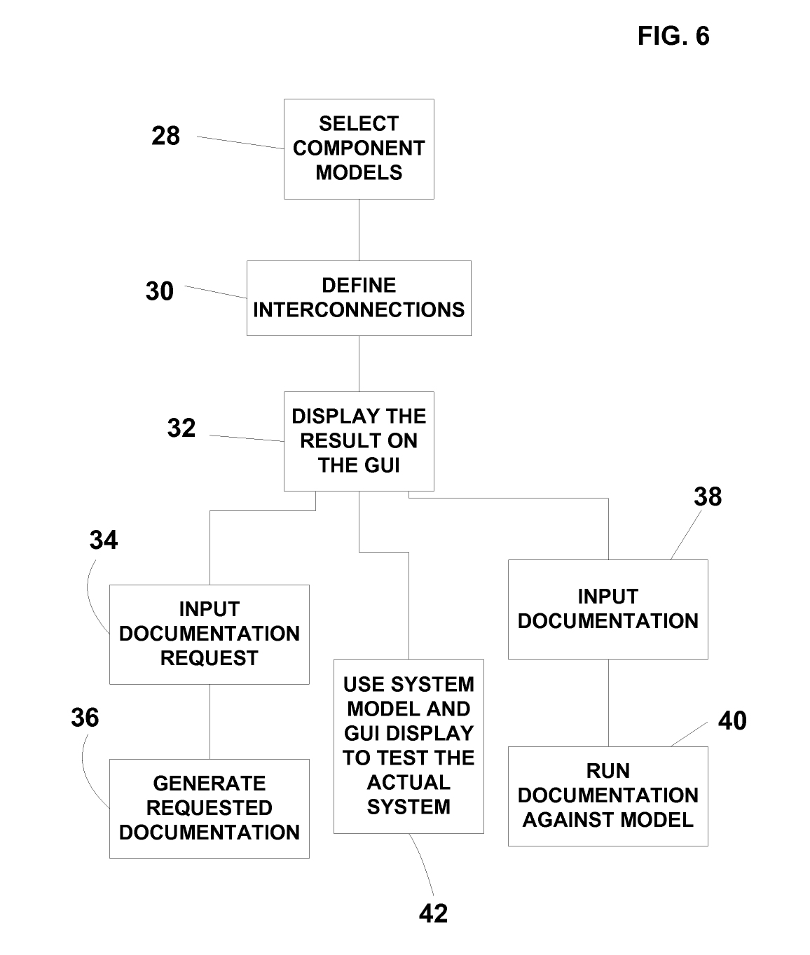

FIG. 6 is a flowchart showing a CAD modeling apparatus embodying the invention. In general, a user will input (28) information to the CAD system for creating a model of a system. The input can include a predefined model written up in a suitable modeling language, or can include commands through the GUI 2, to select system components from a displayed menu of component models 6, select interconnections (30) between components, and assemble them into the system model.

The system does so by referencing the component models 6 within the database 4, and draws on the design information, etc., described above, such as that discussed in connection with FIG. 2.

The resultant combination of component models and interconnections may be represented visually (32), in the GUI 2. The assembled system model, as well as the individual component models, may be rotated and viewed from any desired angle or vantage point. Magnification may also be used in the viewing. Note, incidentally, that the three-dimensional modeling provided by an embodiment of the invention is valuable in the representation of cables, since the twist, bend radius and other geometrical factors affect the electrical performance of the cabling.

Where components or connection cables overlap, they may be displayed with visible indicia of the overlap, such as defocusing, translucency, or highlighting with color, hatching, shading, outlining, etc. Where there are multiple overlapping layers of component models, the user may select a desired layer, such as by clicking on one of that layer's component models. Then, the upper layers that would obstruct view of the desired layer are rendered translucent, the desired layer is highlighted, etc.

Components of the assembled model may be individually identified. For instance, when the user moves a mouse cursor onto a given component, a visual cue, such as a pop-up message, can identify the component, by name, with its properties or operational state, etc. Audio cues for these purposes may also be provided. Also, physical, electrical, logical, or other properties can be monitored at various points in the simulated system by moving the cursor to the corresponding point in the model. The model can be extended with specifications of hardware, firmware, mathematical or other signal inputs, etc. For instance, a fast Fourier transform (FFT) can be added to the model, as part of the modeled system or for analysis of the test system via a user-defined “probe.”

The user may input a request (34) for the apparatus to generate (36) documentation concerning the model. Here are some examples of this: An apparatus embodying the invention can be used to generate a parts list for an assembled model. Also, it can generate a sequence of instructions or steps for assembling such a system. The sequence can match the sequence the user employed for building the model through the graphical user interface, or can develop a different sequence, based on factors such as the most convenient sequence, a topology, or a sequence that best complies with user-entered design criteria. The parts list or assembly instructions can be displayed, printed, or stored for future use, and can be in the form of graphical images such as a slide set showing steep-by-step assembly, or in the form of a written set of instructions.

In an embodiment of the invention, it is possible for the user to input (38) a piece of documentation, and run the documentation (40) against the system model. The piece of documentation might, for instance, include design criteria, properties or use requirements of particular components, etc.

Where the user has entered design criteria, a given assembled model, or assembly sequence, can be checked against the design criteria for compliance or initial debugging. The user can also adjust the parameters of design criteria, options, or rules for a component or for a combination of components. For example, in the case of cables there can be bending design rules, such as minimum bending radii, etc.

In an embodiment of the invention, the properties of the interconnecting cables and their respective inclusion into the system model are specified. Thus, modeling definitions are provided for all elements that constitute pathways in the test system.

Additionally, as the DUT characteristics are derived from measurement, or simulation, the interaction of the DUT with the test system is incorporated into the system model using standard electrical or microwave analysis tools. This includes, for instance, the effects of standing waves produced due to impedance mismatches and propagation delays.

Corrections for these effects are performed to improve measurement accuracy. As an example, suppose that a 3 meter optical cable, such as Corning SMF-28 connects the stimulus to the DUT, the specification of a 3 inch diameter wrapping of the cable provides a corresponding fiber loss, which is known for that diameter wrap and is displayed graphically in a dimensionally correct fashion and the loss is incorporated into the system model. Clicking on the fiber pulls up its state and known specifications. The instrument models are functional models including linear and nonlinear effects.

The assembled system provides archival properties, as well allowing technicians to assemble the system as designed by a test engineer. Where there are multitudes of adjacent cables, rendering of the physical locations and topological shapes is achieved in the GUI, by rendering the ‘outer’ layers translucent so that the highlighted cables performing logical connections may be viewed. Different cables may be highlighted using shading, coloring, crosshatching etc.

One embodiment of a design tool has a design mode, a simulation/analysis mode, and a runtime mode. In the design mode, a 3D representation of the system is constructed, along with a corresponding physical model. In a simulation/analysis mode, the physical model is used to simulate or predict system performance characteristics.

Such an embodiment may be used to create and work with both a system model and an actual physical implementation of the system itself. In a runtime mode, the system model created by the CAD apparatus is linked to the actual components making up the actual system. This makes it possible to control the actual system by manipulating the system model through the user interface 2. Accordingly, the system model and the GUI display can be used to test the actual system (42).

The simulation/analysis mode may include operations such as the following: system elements and connections may be modeled for performance prediction and calibration; employing the design rules and design parameters of component models for system simulation and analysis; modeling system element and connection variability to determine operating regions of system; and modeling physical effects, such as cable rigidity, stiffness, gravity and temperature, to affect the visualization.

The runtime mode may include operations such as the following: clicking on the instrument/DUT contact points, to allow examining or changing instrument/DUT state, or connectivity; altering the instrument state through control interfaces displayed in the 3D representation (e.g. buttons); and displaying the instrument state as part of the 3D representation. Also, in runtime mode, the 3D system visualization is coupled with runtime software error reporting and debugging, so that, for example, instruments that originate errors are highlighted.

In other embodiments, some system elements may run in simulation mode and others in runtime mode. This allows the system to be partially run and partially simulated, to enable full system testing without having all of the hardware. Also, subsets of the full system may be modeled in simulation mode or runtime mode. This allows the system to be built and tested in stages, rather than requiring that all of the hardware be assembled before any testing begins.

In an embodiment, a 3D design tool may be coupled with a tool for designing “virtual” instruments or “virtual” panels (controls and displays) in order to modify or query instrument state that is not physically visible but is available through device drivers (IVI, SCPI) or universal resource locators.

In another embodiment, a 3D design tool may specify collections of instruments and cables, corresponding to a virtual, or “synthetic”, instrument. For example, a down-converter module and IF digitizer module could be specified as a synthetic spectrum analyzer. Using such a virtual instrument capability, vector signal analyzer software and a virtual panel could be associated with the spectrum analyzer hardware. These synthetic components would be available as single, referenceable entities in the model, and in design, simulation, and runtime modes.

A system model, constructed with a 3D design tool embodying the invention, provides a source of component and connection information for operations such as the following:

System simulation and analysis.

Design rule checking.

Generation of a parts list.

Generation of instructions for system construction.

Parameterization of calibration software.

Additional aspects that pertain to the documentation mode, and may appear in embodiments of the invention, include the following:

A computer aided design apparatus, wherein the documentation mode for generating a sequence of steps for assembling includes a sequence of steps for assembling the system based on one of: (a) the sequence the user employed for building the model through the graphical user interface and (b) a different sequence, based on factors such as (i) the most convenient sequence, a topology, or (ii) a sequence that best complies with user-entered design criteria.

A computer aided design apparatus as above, wherein the documentation mode includes: (i) receiving documentation on the system as a user input; and (ii) checking the received user input documentation against the system model.

A computer aided design apparatus as above, wherein the user input documentation includes one of (i) design criteria, (ii) a given assembled model, and (iii) an assembly sequence; and the checking includes comparing the system model with the user input documentation for one of (i) compliance and (ii) debugging.

A computer aided design apparatus as above, wherein, responsive to the comparing, the user adjusts the parameters of one of the design criteria, options, and rules, for one of (i) a component and (ii) a combination of components.

Embodiments of the invention may include apparatus or systems as described herein. Also, embodiments may include methods for practicing the functionality described herein; and computer program products in which software for directing general purpose computers, data processors, etc., to perform the methods described herein is provided in computer-readable media, etc.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A computer aided design apparatus for context-sensitive modeling of a test and measurement system that includes a plurality of actual system components including instruments and interconnections therebetween, the computer aided design apparatus comprising:
a graphical user interface;
a library of models of system components, each model including a graphical representation of the system component and a definition of properties of the system component; and
a system model generator for selecting and interconnecting specified ones of the system components to produce a model of the system, for displaying the model on the graphical user interface as a combination of the graphical representations of the components, and for simulating operation and testing of the system;
wherein the system model generator operates in:
(i) a design mode, for constructing and displaying the model of the system from the models of system components as a graphical representation thereof;
(ii) a simulation/analysis mode, for predicting performance characteristics of the system; and
(iii) a runtime mode for linking to actual system components and operating the actual system components by manipulating the model through the graphical user interface.

2. A computer aided design apparatus as recited in claim 1, wherein the simulation/analysis mode includes a simulation/analysis mode for one of:
(i) predicting performance characteristics of the system;
(ii) manipulating and displaying the simulation and model through the graphical user interface; and
(iii) calibrating one of the system components.

3. A computer aided design apparatus as recited in claim 1, wherein:
the runtime mode includes a runtime mode for linking to the system components, and
(i) operating the system components by manipulating the model through the graphical user interface.

4. A computer aided design apparatus as recited in claim 1, wherein the simulation/analysis mode includes a simulation/analysis mode for generating a simulation of the system that includes simulations of components of the system.

5. A computer aided design apparatus as recited in claim 4, wherein the runtime mode includes a runtime mode for:
(i) linking to specified ones of the system components,
(iii) linking to specified ones of the simulations of components, and
(ii) operating the system components by manipulating respective ones of the linked system components and the linked simulations of components through the graphical user interface.

6. A computer aided design apparatus as recited in claim 1, wherein the system model generator further operates in a documentation mode for generating documentation of the system.

7. A computer aided design apparatus as recited in claim 6, wherein the documentation mode includes a documentation mode for generating one of:
(i) a parts list for the system; and
(ii) a sequence of steps for assembling the system.

8. A computer aided design apparatus as recited in claim 1, wherein:
the system model generator displays the model of the system including physical locations, topological shapes, and layering of the components; and
the respective components are displayed with respective indicia.

9. A computer aided design apparatus as recited in claim 8, wherein the displayed indicia include one of:
translucent display of predetermined upper layers of the components; and
highlighted display of predetermined individual components.

10. A computer aided design method for context-sensitive modeling of a test and measurement system that includes a plurality of actual system components including instruments and interconnections therebetween, for use with a system including a graphical user interface and a library of models of system components, each model including a graphical representation of the system component and a definition of properties of the system component, the computer aided design method comprising:
selecting and interconnecting specified ones of the system components to generate a model of the system, for displaying the model on the graphical user interface as a combination of the graphical representations of the components, and for simulating operation and testing of the system;
operating in a design mode, for constructing and displaying the model of the system from the models of system components as a graphical representation thereof;
operating in a simulation/analysis mode, for predicting performance characteristics of the system; and
operating in a runtime mode for linking to actual system components and operating the actual system components by manipulating the model through the graphical user interface.

11. A computer aided design method as recited in claim 10, wherein the operating in a simulation/analysis mode includes one of:
(i) predicting performance characteristics of the system;
(ii) manipulating and displaying the simulation and model through the graphical user interface; and
(iii) calibrating one of the system components.

12. A computer aided design method as recited in claim 10, wherein the operating in a runtime mode includes:
linking to the system components, and
operating the system components by manipulating the model through the graphical user interface.

13. A computer aided design method as recited in claim 10, wherein the operating in a simulation/analysis mode includes generating a simulation of the system that includes simulations of components of the system.

14. A computer aided design method as recited in claim 13, wherein the operating in a runtime mode includes:
(i) linking to specified ones of the system components,
(iii) linking to specified ones of the simulations of components, and
(ii) operating the system components by manipulating respective ones of the linked system components and the linked simulations of components through the graphical user interface.

15. A computer aided design method as recited in claim 10, further comprising operating in a documentation mode for generating documentation of the system.

16. A computer aided design method as recited in claim 15, wherein the operating in a documentation mode includes generating one of:
(i) a parts list for the system; and
(ii) a sequence of steps for assembling the system.

17. A computer aided design method as recited in claim 10, further comprising:
displaying the model of the system including physical locations, topological shapes, and layering of the components; and
displaying the respective components with respective indicia.

18. A computer aided design apparatus as recited in claim 17, wherein the displaying with respective indicia include one of:
translucent display of predetermined upper layers of the components; and
highlighted display of predetermined individual components.

19. A computer program product for directing a processor to perform a computer aided design method for context-sensitive modeling of a test and measurement system that includes a plurality of actual system components including instruments and interconnections therebetween, for use with a system including a graphical user interface and a library of models of system components, each model including a graphical representation of the system component and a definition of properties of the system component, the computer program product comprising:
a computer-readable medium; and
computer program code, provided on the computer-readable medium, for directing the processor to:
select and interconnect specified ones of the system components to generate a model of the system, for displaying the model on the graphical user interface as a combination of the graphical representations of the components, and for simulating operation and testing of the system;
operate in a design mode, for constructing and displaying the model of the system from the models of system components as a graphical representation thereof;
operate in a simulation/analysis mode, for predicting performance characteristics of the system; and
operate in a runtime mode for linking to actual system components and operating the actual system components by manipulating the model through the graphical user interface.
